(19) United States
(12) Patent Application Publication
(10) Pub. No.: US 2014/0081723 A1
(43) Pub. Date: Mar. 20, 2014

(54) INFORMATION PROVIDING APPARATUS, INFORMATION PROVIDING METHOD, AND NON-TRANSITORY COMPUTER-READABLE STORAGE MEDIUM

(71) Applicant: YAHOO JAPAN CORPORATION, Tokyo (JP)

(72) Inventors: Mitsuru MUGUCHI, Tokyo (JP); Shinsuke SATOU, Tokyo (JP)

(73) Assignee: YAHOO JAPAN CORPORATION, Tokyo (JP)

(21) Appl. No.: 13/962,422

(22) Filed: Aug. 8, 2013

(30) Foreign Application Priority Data
Sep. 14, 2012 (JP) 2012-202334

(51) Int. Cl. G06Q 30/02

(52) U.S. Cl. CPC G06Q 30/0214
USPC 705/14.16

(57) ABSTRACT

An information providing apparatus according to the present application includes an identifying unit, a checking unit, and a notifying unit. The identifying unit identifies a store or a site which a user plans to visit by analyzing a posting page posted by the user. The checking unit checks a current location of a user terminal which the user has against a location of the store or the site identified by the identifying unit when the user terminal performs processing to register the current location. The notifying unit notifies an administrator of the store or the site that the user has actually visited the store or the site when the current location of the user terminal is the same as the location of the store or the site as a result of the check performed by the checking unit.

### CROSS-REFERENCE TO RELATED APPLICATIONS

The present application claims priority to and incorporates by reference the entire contents of Japanese Patent Application No. 2012-202334 filed in Japan on Sep. 14, 2012.

### BACKGROUND OF THE INVENTION

1. Field of the Invention

The present invention relates to an information providing apparatus, an information providing method, and a non-transitory computer-readable storage medium.

2. Description of the Related Art

It has been found that users post articles relating to the user's actions, for example, on web pages such as weblogs (hereinafter described as the “blogs”). For example, in some cases, the users post not only articles relating to the actions already done, but also articles relating to the actions that the users plan to do.

It has been known that the posting of articles relating to products on such web pages advertise the products. For example, when a new product is planned to be sold at a certain store or event, and an article stating the purchase of the product is posted before the selling date, the posting web page publishes information relating to the product, thereby advertising the product and the store.

As a technique relating to a user's planned action, a technique is known in which an action support server produces action support information suitable for supporting the achievement of an action planned by a user and for suggesting an action executable together with the planned action, and transmits the information to a user terminal (refer to Japanese Patent Application Laid-open No. 2004-271321). The technique may make it possible to actualize the user's subconsciousness, and, for the user, to suggest a moment for starting an optimum action, provide a feeling of security on stable progress after the start of the action, and support an action for multiple purposes.

The posting of the article relating to the store advertises the store and the actual visit of the user brings profit to the store. That is, the user who not only posts the article but also actually visits the store is highly beneficial to the store. Hence, the store may give an incentive such as a discount service to the highly beneficial user. This incentive may promote the user to post the articles relating to the store, thereby making it possible to enhance the effect of advertising the store.

The conventional technique, however, has a problem in that it is difficult to enhance the effect of advertising the store using the web page posted by such a user. Specifically, it is difficult for the conventional technique to identify whether a user who posted an article has actually visited the store because articles on web pages such as blogs are generally posted anonymously. For this reason, the store cannot give an incentive to such a highly beneficial user. The technique described in Japanese Patent Application Laid-open No. 2004-271321 simply provides information of facilities and the like as the action support information and does not identify whether the user who posted the article actually visited the store.

### SUMMARY OF THE INVENTION

According to one aspect of an embodiment, an information providing apparatus includes an identifying unit which identifies a store or a site which a user plans to visit by analyzing a posting page posted by the user, a checking unit which checks a current location of a user terminal which the user has against a location of the store or the site identified by the identifying unit when the user terminal performs processing to register the current location, and a notifying unit which notifies an administrator of the store or the site that the user has actually visited the store or the site when the current location of the user terminal is the same as the location of the store or the site as a result of the check performed by the checking unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram for explaining an example of notification processing according to an embodiment of the present application;

FIG. 2 is a schematic diagram illustrating an exemplary structure of a network system in the embodiment;

FIG. 3 is a schematic diagram illustrating an exemplary structure of a web server in the embodiment;

FIG. 4 is a schematic diagram illustrating an example of a web page storage unit in the embodiment;

FIG. 5 is a schematic diagram illustrating an exemplary structure of an image providing apparatus in the embodiment;

FIG. 6 is a schematic diagram illustrating an example of a user information storage unit in the embodiment;

FIG. 7 is a schematic diagram illustrating an example of a store information storage unit in the embodiment;

FIG. 8 is a sequence diagram illustrating processing performed by the network system in the embodiment to identify a planned visiting store; and

FIG. 9 is a sequence diagram illustrating the notification processing performed by the network system in the embodiment.

### DETAILED DESCRIPTION OF THE PREFERRED EMBODIMENT

The following describes an embodiment of an information providing apparatus, an information providing method, and an information providing program according to the present application (hereinafter called the “embodiment”) in detail with reference to the accompanying drawings. This embodiment does not limit the information providing apparatus, the information providing method, and the information providing program according to the present application. In the embodiment, the same components are denoted by the same reference numerals and duplicated explanations thereof are omitted.

1. Notification Processing

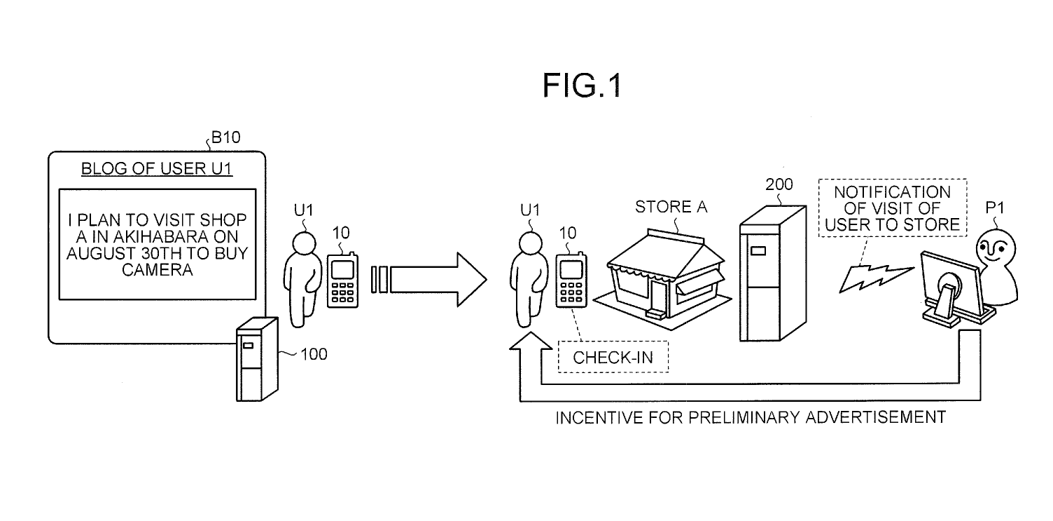

Notification processing according to the embodiment is described with reference to FIG. 1. FIG. 1 is a schematic diagram for explaining an example of the notification processing in the embodiment. In the example illustrated in FIG. 1, a user terminal 10 is a mobile phone (e.g., a smartphone) or a personal digital assistant (PDA), for example, which is used by a user U1.

The user U1 posts an article relating to the user's planned actions on a web server 100. In the example illustrated in FIG. 1, the user U1 posts an article stating that “I plan to visit a store A in Akihabara on August 30”. As a result, the web server 100 publishes a web page B10 in which the article stating such a content is written. The user U1 may post articles using the user terminal 10 or another terminal (not illustrated) such as a personal computer.

In the notification processing of the embodiment, an information providing apparatus 200 managing a website of the store A identifies the store that the user U1 plans to visit by analyzing the blog page B10 posted on the web server 100. For example, the information providing apparatus 200 identifies the store the user U1 plans to visit by extracting the date or the store name by morphologically analyzing the article written on the blog page B10.

Thereafter, the user U1 actually visits the store A and registers the user's current location in the store A using the user terminal 10. The registration of the current location is called a check-in or a location registration and means that the user terminal 10 such as a mobile phone transmits the location to a certain server. In the example of FIG. 1, the information providing apparatus 200 provides a location registration service and the user terminal 10 registers the current location to the information providing apparatus 200.

When the location registration is performed by the user terminal 10, the information providing apparatus 200 checks the current location of the user terminal 10 against the location of the store A (the store that the user U1 plans to visit) identified as described above. If the result of the check shows the current location of the user terminal 10 is the same as the location of the store A, the information providing apparatus 200 notifies an administrator P1 (e.g., a business manager or a store manager) of the store A that the user U1 has actually visited the store A.

In this way, in the notification processing of the embodiment, it is possible to determine whether the user who posted an article relating to the store A has actually visited the store A. This makes it possible to associate the user who posted the article relating to the store A with the user who visits the store A. As a result, the administrator P1 of the store A can recognize that the user U1 who preliminarily posted the article stating the visit of the user U1 to the store A has actually visited the store A, thereby making it possible to give an incentive to the user U1 for preliminarily advertising the store A on the web page. That is, the notification processing of the embodiment can promote users to post information of the store, thereby making it possible to enhance the effects of advertising stores and the like using the web pages posted by the users.

The information providing apparatus 200 may perform processing to swap links between the website of the store A and the blog page B10 when the current location of the user terminal 10 is the same as the location of the store A. For example, the information providing apparatus 200 notifies the web server 100 of a track back uniform resource locator (URL) of the website of the store A. The web server 100 performs a track back such that the website of the store A is referred to from the blog page B10. As a result, the link to the website of the store A is displayed on the blog page B10 because the track back of the website of the store A is displayed. On the website of the store A, the link to the blog page B10 is displayed because the track back of the blog page B10 is displayed.

The swapping of links makes it possible to promote browsing users who browse the website of the store A to browse the blog page B10 posted by the user U1 who has actually visited the store A, thereby making it possible to enhance the effect of advertising the store A. Likewise, the swapping of links makes it possible to promote browsing users who browse the blog page B10 to browse the website of the store A, thereby making it possible to enhance the effect of advertising the store A. The following describes a network that performs such notification processing in detail.

2. Structure of Network System

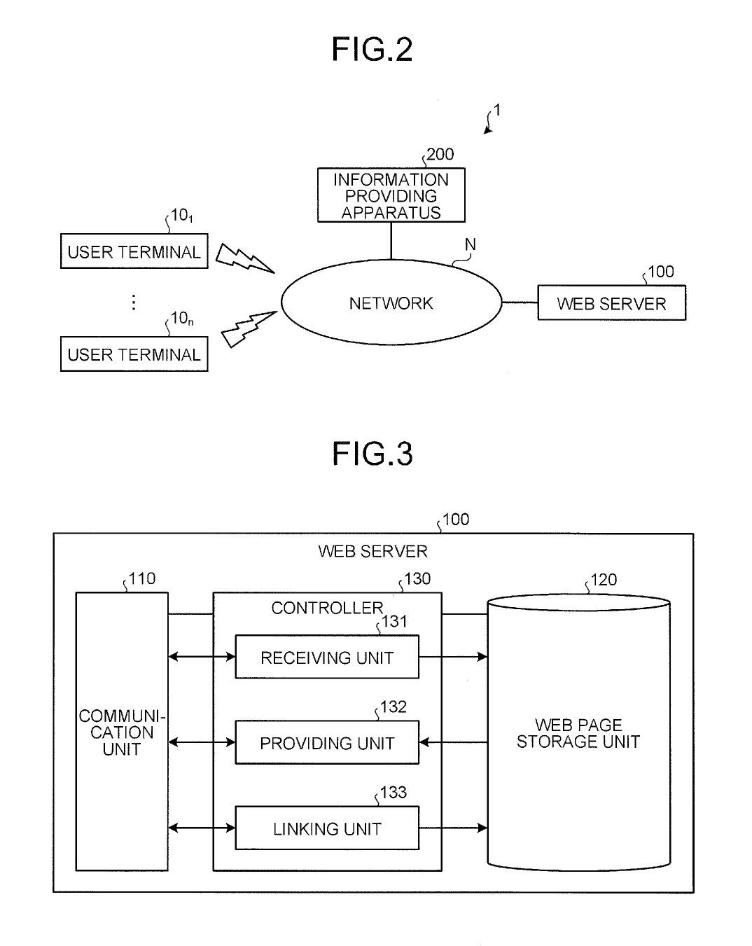

FIG. 2 is a schematic diagram illustrating an exemplary structure of a network system according to the embodiment. As illustrated in FIG. 2, a network system 1 in the embodiment includes user terminals 10₁ to 10ₙ, the web server 100, and the information providing apparatus 200. The user terminals 10₁ to 10ₙ, the web server 100, and the information providing apparatus 200 are coupled to each other through a network N in a wired or wireless manner so as to enable communications therebetween.

Each of the user terminals 10₁ to 10ₙ corresponds to the user terminal 10 illustrated in FIG. 1. In the following description, the user terminals 10₁ to 10ₙ may be collectively described as the “user terminal 10” when they do not need to be differentiated from each other. The user terminal 10 has a global positioning system (GPS) receiving function and acquires the current location of the user terminal 10. Specifically, the user terminal 10 receives radio waves sent from GPS satellites and acquires location information (e.g., the latitude and longitude) of the user terminal 10 on the basis of the received radio waves. The user terminal 10 has a function to transmit the location information to a certain server (the information providing apparatus 200 in the example of FIG. 2) in accordance with the user's operation to register the current location of the user terminal 10.

The web server 100 transmits a hypertext markup language (HTML) text corresponding to the URL accessed by the user terminal 10 to the user terminal 10 in accordance with a hypertext transfer protocol (HTTP), for example. The web server 100 in the embodiment is a blog server that provides blog pages (e.g., the blog page B10 illustrated in FIG. 1).

The information providing apparatus 200 transmits the HTML text corresponding to the URL accessed by the user terminal 10 to the user terminal 10 in accordance with the HTTP, for example. The information providing apparatus 200 in the embodiment is a server that provides websites of stores such as restaurants, clothing stores, department stores, pharmacies, and electronics retail stores. For example, the information providing apparatus 200 is a server that provides portal sites.

The network system 1 in the example illustrated in FIG. 2, includes the single web server 100 and the single information providing apparatus 200, but the network system 1 may include a plurality of web servers 100 and a plurality of information providing apparatuses 200.

3. Structure of Web Server

The web server 100 illustrated in FIG. 2 is described below with reference to FIG. 3. FIG. 3 is a schematic diagram illustrating an exemplary structure of the web server 100 in the embodiment. As illustrated in FIG. 3, the web server 100 includes a communication unit 110, a web page storage unit 120, and a controller 130. The web server 100 may include an input unit (e.g., a keyboard or a mouse) that receives various types of operation from an administrator or the like of the web server 100 and a display that displays various types of information.

The Communication Unit 110

The communication unit 110 is connected to the network N and exchanges information between itself and the user terminal 10 and the information providing apparatus 200 through the network N. The communication unit 110 is connected to the network N in a wired or wireless connection manner and achieved by a network interface card (NIC), for example.

The Web Page Storage Unit 120

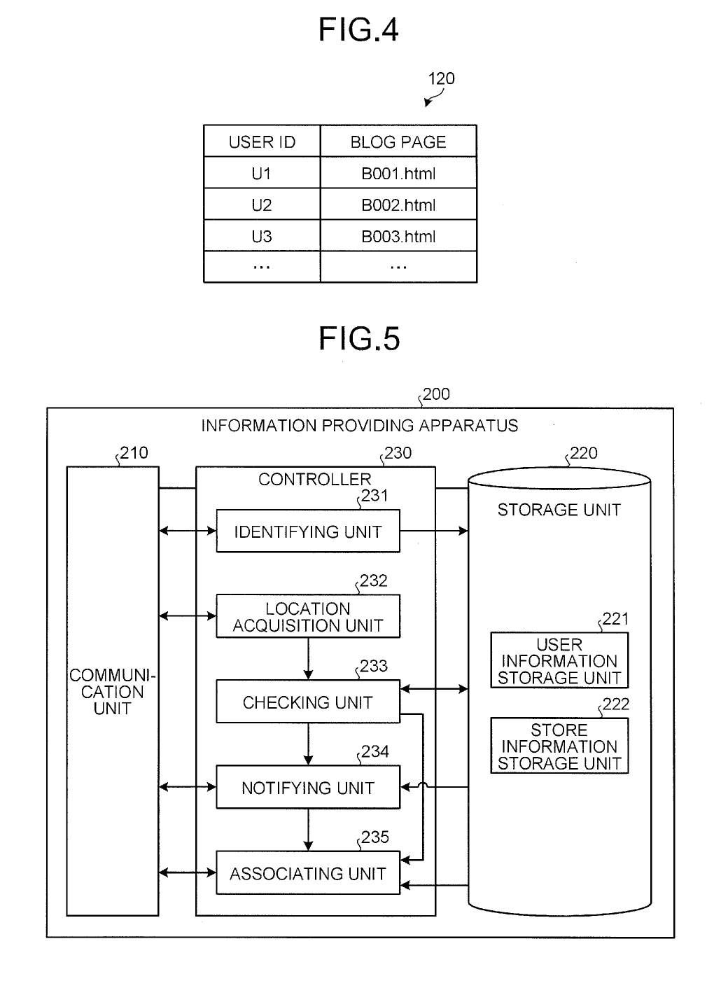

The web page storage unit 120 is achieved by a semiconductor memory element such as a random access memory (RAM) or a flash memory, or a storage device such as a hard disk drive or an optical disk. The web page storage unit 120 stores therein various types of information relating to web pages provided by the web server 100. FIG. 4 illustrates an example of the web page storage unit 120 in the embodiment. As illustrated in FIG. 4, the web page storage unit 120 includes a “user ID” and a “blog page” as the information items.

The “user ID” indicates identification information to identify the respective users using the user terminal 10. The “blog page” indicates the HTML files of the blogs in which the articles posted by the users are written.

For example, in FIG. 4, it is indicated that the blog page posted by the user identified by the user ID of “U1” is “B001.html”. In the example illustrated in FIG. 4, the web page storage unit 120 stores a single blog page (HTML file) in association with each user. The web page storage unit 120 can store a set of multiple blog pages in association with each user.

The Controller 130

The controller 130 is achieved by a central processing unit (CPU) or a micro processing unit (MPU) executing a computer program stored in an internal storage device using a RAM as a working area, for example. The controller 130 is achieved by an integrated circuit such as an application specific integrated circuit (ASIC) or a field programmable gate array (FPGA).

As illustrated in FIG. 3, the controller 130 includes a receiving unit 131, a providing unit 132, and a linking unit 133, and achieves or executes a function and operation of information processing described below. The internal structure of the controller 130 is not limited to that illustrated in FIG. 3, and may be any other structure that performs the information processing described later.

The Receiving Unit 131

The receiving unit 131 receives the posting of article data written on the blog page from the user terminal 10. The receiving unit 131 produces the HTML file on the basis of the received article data and stores the produced HTML file in the web page storage unit 120.

For example, the receiving unit 131 provides an input form to post a blog page to the user terminal 10 and receives the posting of the article data. The receiving unit 131 causes a user to log in the web server 100 from the user terminal 10, thereby acquiring the user ID of the user and storing the article data in the web page storage unit 120 in association with the acquired user ID.

The Providing Unit 132

The providing unit 132 provides the blog page stored in the web page storage unit 120. Specifically, when receiving an HTTP request from the user terminal 10 or the information providing apparatus 200, the providing unit 132 acquires the blog page corresponding to the HTTP request from the web page storage unit 120. Then, the providing unit 132 provides the acquired blog page to the transmission origin of the HTTP request (the user terminal 10 or the information providing apparatus 200).

The Linking Unit 133

When an associating unit 235, which is described later, of the information providing apparatus 200 notifies the linking unit 133 of the URL of the website of a store, the linking unit 133 causes the blog page to display the link to the website of the store thereon. When the track back URL of the website is notified from the associating unit 235, the linking unit 133 performs track back so as to cause the blog page to refer to the website. The processing performed by the linking unit 133 is described later together with the processing performed by the associating unit 235.

4. Structure of Information Providing Apparatus

The information providing apparatus 200 illustrated in FIG. 2 is described below with reference to FIG. 5. FIG. 5 is a schematic diagram illustrating an exemplary structure of the information providing apparatus 200 in the embodiment. As illustrated in FIG. 5, the information providing apparatus 200 includes a communication unit 210, a storage unit 220, and a controller 230. The information providing apparatus 200 may include an input unit (e.g., a keyboard or a mouse) that receives various types of operation from an administrator or the like of the information providing apparatus 200 and a display that displays various types of information.

The Communication Unit 210

The communication unit 210 is connected to the network N and exchanges information between itself and the user terminal 10 and the web server 100 through the network N. The communication unit 210 is connected to the network N in a wired or wireless connection manner and achieved by a NIC, for example.

The Storage Unit 220

The storage unit 220 is achieved by a semiconductor memory element such as a RAM or a flash memory, or a storage device such as a hard disk drive or an optical disk. As illustrated in FIG. 5, the storage unit 220 includes a user information storage unit 221 and a store information storage unit 222.

The User Information Storage Unit 221

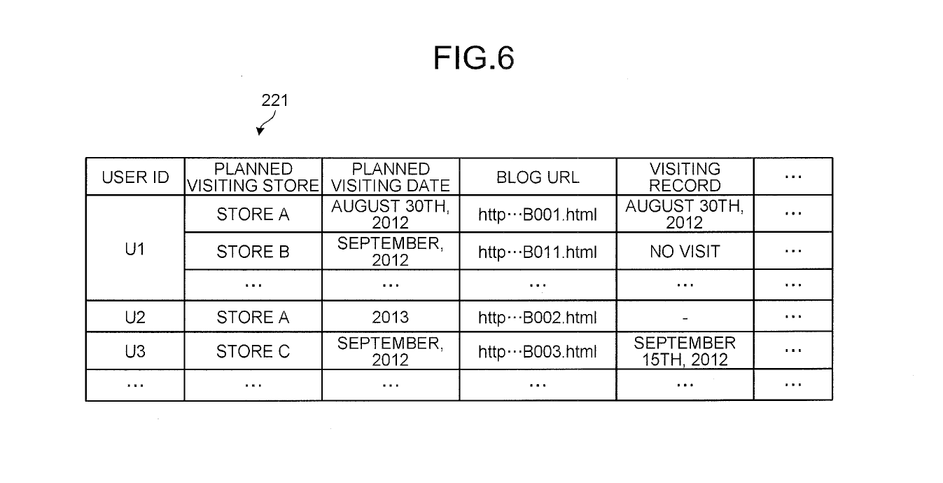

The user information storage unit 221 stores therein various types of information relating to users of the user terminal 10. FIG. 6 illustrates an example of the user information storage unit 221 in the embodiment. As illustrated in FIG. 6, the user information storage unit 221 includes a “user ID”, a “planned visiting store”, a “planned visiting date” and a “blog URL”, and a “visiting record” as the information items.

The “user ID” indicates identification information to identify respective users using the user terminal 10. The “planned visiting store” indicates the stores that are written on the blog pages posted by the users and planned to be visited by the users. The “planned visiting date” indicates the dates that are written on the blog pages posted by the users and planned dates when the users will visit the planned visiting stores. The “blog URL” indicates the URLs of the blog pages posted by the users. The “visiting record” indicates whether the users have actually visited the planned visiting stores. In the examples illustrated in the “visiting record” of FIG. 6, the visiting date is stored in the case that the user visited the planned visiting store and the information of “no visit” is recorded in the case that the user did not visit the planned visiting store.

For example, in FIG. 6, it is indicated that the user identified by the user ID of “U1” had planned to visit the store A on Aug. 30, 2012, and visited the store A on Aug. 30, 2012. In FIG. 6, it is also indicated that the user identified by the user ID of “U1” had planned to visit the store B in September 2012, but actually did not visit the store B. As illustrated in FIG. 6, the planned visiting date may be stored in “month/day/year”, “month/year”, or “year” format, from the time units year, month, day, hour, minute, and second to indicate the time and date.

The Store Information Storage Unit 222

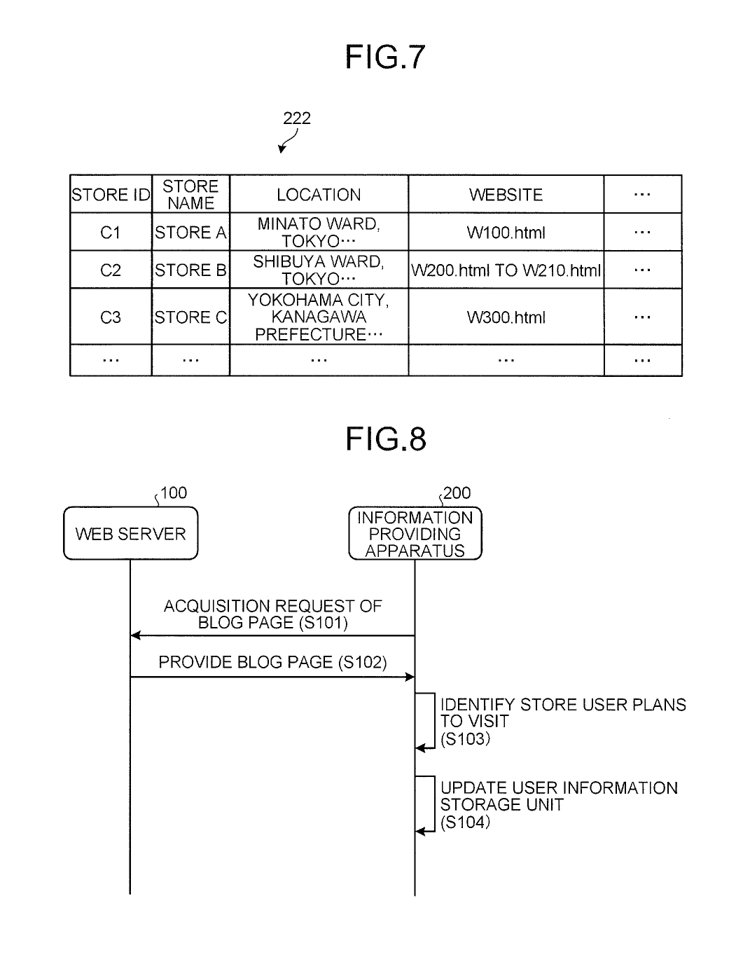

The store information storage unit 222 stores therein various types of information relating to the stores managed by the information providing apparatus 200. FIG. 7 illustrates an example of the store information storage unit 222 in the embodiment. As illustrated in FIG. 7, the store information storage unit 222 includes a “store ID”, a “store name”, a “location”, and a “website” as the information items.

The “store ID” indicates identification information to identify the respective stores such as restaurants and clothing stores. The “store name” indicates the names of the stores identified by the store IDs. The “location” indicates the locations of the stores. In the example of FIG. 7, the addresses of the stores are stored in the “location”. The “website” indicates the HTML files of the websites of the stores.

For example, in FIG. 7, it is indicated that the store A identified by the store ID of “C1” is located at “Minato ward, Tokyo” and the website of the store A is formed by “W100.html”.

The Controller 230

The controller 230 is achieved by a CPU or an MPU executing a computer program (an example of an information providing program) stored in an internal storage device using a RAM as a working area, for example. The controller 230 is achieved by an integrated circuit such as an ASIC or an FPGA, for example.

As illustrated in FIG. 5, the controller 230 includes an identifying unit 231, a location acquisition unit 232, a checking unit 233, a notifying unit 234, and the associating unit 235, and achieves or executes a function and operation of information processing described below. The internal structure of the controller 230 is not limited to that illustrated in FIG. 5 and may be any other structure that performs the information processing described later.

The Identifying Unit 231

The identifying unit 231 analyzes the blog page posted by a user and identifies the store the user plans to visit. Specifically, the identifying unit 231 accesses the web server 100, acquires the blog page from the providing unit 132 of the web server 100, and analyzes the articles written on the acquired blog page. For example, the identifying unit 231 extracts morphological elements corresponding to dates and stores by morphologically analyzing the articles. When detecting a “store name” and a “(future) date later than the current date”, the identifying unit 231 stores the extracted store name in the planned visiting store in the user information storage unit 221 and stores the extracted date in the planned visiting date in the user information storage unit 221. The identifying unit 231 acquires the user ID used by the user when posting the blog page from the web server 100, and stores the planned visiting store and the planned visiting date in the user information storage unit 221 in association with the acquired user ID.

The Location Acquisition Unit 232

When the user terminal 10 transmits the location information, the location acquisition unit 232 outputs the location information to the checking unit 233. Specifically, the user terminal 10 transmits the location information of the current location to the information providing apparatus 200 in accordance with user's operation as described above. The user terminal 10 in the embodiment transmits to the information providing apparatus 200 the location information of the current location, a registration date when location registration processing was performed, and the user ID used by the user when posting the blog page on the web server 100. The location acquisition unit 232 outputs a set of the location information, the registration date, and the user ID, which are received from the user terminal 10, to the checking unit 233. The location acquisition unit 232 may store the location information and the registration date, which are received from the user terminal 10, in a storage unit (not illustrated) in association with each other.

The location acquisition unit 232 achieves a function allowing a user to notify a friend of the user's location and performs processing to register the current location of the user terminal 10 as a log, in a social networking service (SNS), for example. The description of the processing to register the current location is omitted because the processing is not much associated with the processing performed by the information providing apparatus 200 in the embodiment.

The location acquisition unit 232 need not directly receive the location information from the user terminal 10 and may acquire the location information of the user terminal 10 from another server providing a location registration service.

The Checking Unit 233

When the user terminal 10 performs the processing to register the current location, the checking unit 233 checks the current location of the user terminal 10 against the location of the store (the store that the user U1 plans to visit) identified by the identifying unit 231.

Specifically, the checking unit 233 checks the location information input from the location acquisition unit 232 against the location stored in the store information storage unit 222, and identifies the store where the user is present. When the checking unit 233 cannot identify the store where the user is present or the user is not present in the store, the checking unit 233 ends the processing. When identifying the store where the user is present, the checking unit 233 checks whether the identified store is the same as the planned visiting store stored in the user information storage unit 221 in association with the user ID input from the location acquisition unit 232. When both stores are the same, the checking unit 233 stores the registration date input from the location acquisition unit 232 in the visiting record of the user information storage unit 221.

When the planned visiting date stored in the user information storage unit 221 is a past date earlier than the current date, the checking unit 233 may end the processing without performing the checking processing described above. In this case, the checking unit 233 stores the information of “no visit” in the visiting record of the user information storage unit 221.

In the example illustrated in FIG. 7, the addresses of the respective stores are stored under the item of location of the store information storage unit 222. Alternatively, the store information storage unit 222 may store the location information (e.g., the latitude and longitude) of each store. In this case, the checking unit 233 identifies, as the store where the user is present, the store corresponding to the location information a difference of which from the location information input from the location acquisition unit 232 is equal to or smaller than a certain threshold, out of the location information stored in the store information storage unit 222.

The Notifying Unit 234

The notifying unit 234 notifies the administrator or the like of the store that the user has actually visited the store if the result of the check performed by the checking unit 233 shows the store where the user is present is the same as the planned visiting store. For example, the notifying unit 234 notifies a terminal device (e.g., a mobile phone or a personal computer) the administrator or the like of the store uses or a terminal device installed in the store that the user has actually visited the store.

An example is described below, assuming that the result of the check performed by the checking unit 233 shows the current location of the user having the user ID of “U1” illustrated in FIG. 6 is the same as the location of the store A. In this case, the notifying unit 234 notifies the administrator or the like of the store A that the user having the user ID of “U1” has visited the store A.

As a result, the administrator or the like of the store can recognize that the user who preliminarily posted the article stating the visit to the store has actually visited the store, thereby making it possible to give an incentive to the user for preliminarily advertising the store on the blog page. For example, the information providing apparatus 200 acquires a mail address from the user terminal 10 and notifies the administrator or the like of the store of the acquired mail address. The administrator or the like of the store can give an incentive by transmitting a coupon to the mail address of the user terminal 10, for example.

The Associating Unit 235

The associating unit 235 associates the website of the store with the blog page posted by the user if the result of the check performed by the checking unit 233 shows the store where the user is present is the same as the planned visiting store. Specifically, the associating unit 235 edits the website stored in the store information storage unit 222 in association with the store ID of the store where the user is present, and causes the website to display the link to the blog URL stored in the user information storage unit 221.

The associating unit 235 notifies the linking unit 133 in the web server 100 of the URL of the edited website. Then, the linking unit 133 of the web server 100 edits the blog page stored in the web page storage unit 120, and causes the blog page to display the link to the website of the store.

In the same manner as the example described above, it is assumed that the result of the check performed by the checking unit 233 shows the current location of the user having the user ID of “U1” illustrated in FIG. 6 is the same as the location of the store A. In this case, the associating unit 235 acquires, from the user information storage unit 221, the blog URL “http . . . B001.html” stored in association with the user ID “U1” and the “store A” under the item of planned visiting store. The associating unit 235 edits the website “W100.html” stored in the store information storage unit 222 in association with the store ID “C1” (“store A” in the item of the store name), and causes the website to display the link to the blog URL “http . . . B001.html”.

The associating unit 235 transmits, to the web server 100, the blog URL “http . . . B001.html” and the URL of the website “W100.html”, and instructs the blog page “B001.html” to display the link to the website “W100.html”. Then, the linking unit 133 of the web server 100 edits the blog page “B001.html” stored in the web page storage unit 120, and causes the blog page to display the link to the website “W100.html”.

In the example described above, the associating unit 235 edits the website and the linking unit 133 edits the blog page. The track back, however, is not limited to the example. The associating unit 235 may notify the web server 100 of the track back URL of the website and instruct the web server 100 to perform the track back of the website. For example in this case, the associating unit 235 transmits the blog URL “http . . . B001.html” and the track back URL of the website “W100.html” to the web server 100. The linking unit 133 of the web server 100 performs the track back such that the blog page “B001.html” refers to the website “W100.html”.

In this way, when the user who posted the blog page relating to the planned visiting store actually visited the store, the associating unit 235 causes the blog page and the website of the store to swap the links therebetween.

5. Processing to Identify Planned Visiting Store

The following describes processing performed by the network system 1 in the embodiment to identify the planned visiting store with reference to FIG. 8. FIG. 8 is a sequence diagram illustrating the processing performed by the network system 1 in the embodiment to identify the planned visiting store.

As illustrated in FIG. 8, the receiving unit 131 of the web server 100 receives the posting of the article data to be written on the blog page from the user terminal 10. The receiving unit 131 stores the received article data in the web page storage unit 120.

The identifying unit 231 of the information providing apparatus 200 transmits an acquisition request of the blog page (HTTP request) to the web server 100 (step S101). The providing unit 132 of the web server 100 provides the blog page to the information providing apparatus 200 in accordance with the acquisition request received from the identifying unit 231 (step S102).

The identifying unit 231 of the information providing apparatus 200 analyzes the blog page acquired from the web server 100 and identifies the store the user plans to visit (step S103). The identifying unit 231 updates the user information storage unit 221 based on the identified the store the user plans. The identifying unit 231 periodically performs the processing from step S102 to step S104.

6. Notification Processing

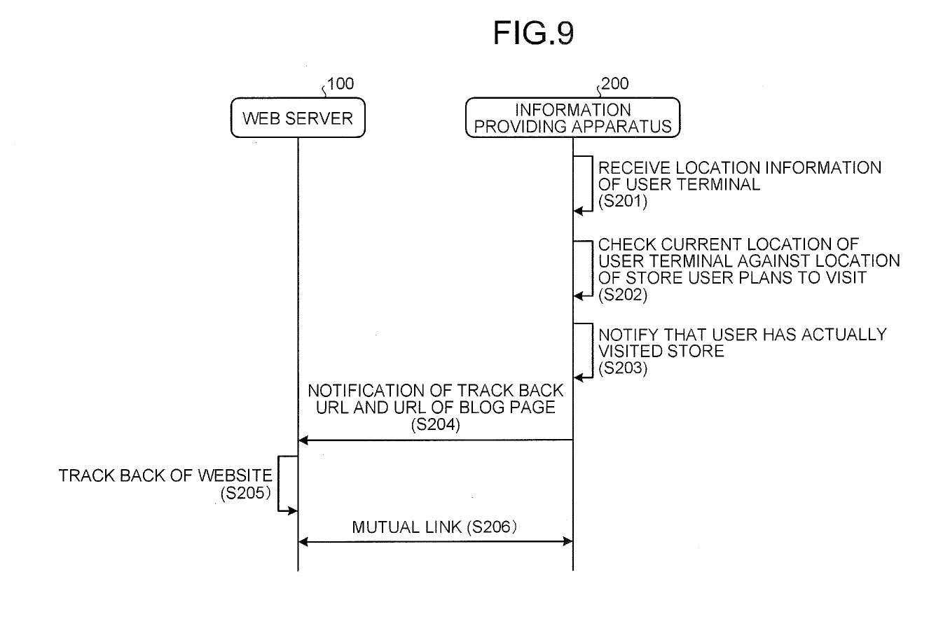

The following describes notification processing performed by the network system 1 in the embodiment with reference to FIG. 9. FIG. 9 is a sequence diagram illustrating the notification processing performed by the network system 1 in the embodiment. FIG. 9 illustrates an example where the website and the blog page are associated with each other by the track back.

As illustrated in FIG. 9, when the location acquisition unit 232 receives the current location from the user terminal 10 (step S201), the checking unit 233 checks the current location of the user terminal 10 against the location of the store that the user of the user terminal 10 plans to visit on the basis of the various types of information stored in the user information storage unit 221 and the store information storage unit 222 (step S202).

If the result of the check performed by the checking unit 233 shows the current location of the user terminal 10 is the same as the location of the planned visiting store, the checking unit 233 notifies the administrator or the like of the store that the user of the user terminal 10 has actually visited the store (step S203).

Subsequently, the associating unit 235 notifies the web server 100 of the track back URL of the website of the store and the URL of the blog page (step S204). Then, the linking unit 133 of the web server 100 identifies the blog page that is a referring origin and performs the track back such that the identified blog page refers to the track back URL (i.e., the website of the store) (step S205). As a result, the links are swapped between the blog page posted by the user and the website of the store (step S206).

7. Modifications

The network system 1 in the embodiment may be implemented in various ways besides the above-described embodiment. The following describes other embodiments of the network system 1.

7-1. Evaluation of User

In the example of the embodiment described above, the associating unit 235 associates the website of the store with the blog page when the store where the user is present is the same as the planned visiting store. The association, however, is not limited to the example. The associating unit 235 may determine whether the website of the store and the blog page are associated with each other on the basis of the visiting record stored in the user information storage unit 221.

Specifically, in the visiting record of the user information storage unit 221, past action histories are stored that indicate whether the users actually visited the store. The associating unit 235 may calculate evaluation values of the respective users on the basis of the visiting record. For example, the associating unit 235 calculates the evaluation value in such a manner that the lower a rate of the number of times a user visited the store to the number of postings of articles stating that the user plans to visit the store, the lower the calculated evaluation value of the user. In contrast, the higher the rate of the number of times a user actually visited the store to the number of postings of articles stating that the user plans to visit the store, the higher the calculated evaluation value of the user. The associating unit 235 does not associate the website of the store with the blog page when the evaluation value of a user is equal to or smaller than a certain threshold even if the store where the user is present is the same as the planned visiting store as a result of the check performed by the checking unit 233. In contrast, the associating unit 235 associates the website of the store with the blog page when the evaluation value of a user is larger than a certain threshold and the store where the user is present is the same as the planned visiting store.

As a result, the associating unit 235 can associate the blog page posted by a user who has actually visited the store with high certainty with the website of the store, thereby making it possible to promote browsing users who browse the website of the store to browse the blog page having high credibility and reliability.

The processing to calculate the evaluation values of users is not limited to the example described above. For example, the associating unit 235 may calculate the evaluation value in such a manner that the larger the number of times a user visited the store, the higher the calculated evaluation value of the user, besides the visiting record of the user information storage unit 221. For another example, the associating unit 235 may calculate the evaluation value in such a manner that the larger the number of types of stores a user visited, the higher the evaluation value of the user. This is because it can be said that the credibility of articles posted by a user who visits many stores many times is high. By calculating the evaluation value as described in the example, the associating unit 235 can promote browsing users who browse the website of the store to browse the blog pages having high credibility and reliability.

7-2. Mutual Link

In the example of the embodiment described above, the associating unit 235 associates the website of the store with the blog page when the store where the user is present is the same as the planned visiting store. The swapping of the links, however, is not limited to the example. The associating unit 235 may link the blog page to the website of the store when the blog page is posted by a user and link the website of the store to the blog page when the store where the user is present is the same as the planned visiting store.

This makes it possible to promote users who browse the blog page to browse the home page of the store at the time when the blog page is posted, thereby making it possible to enhance the effect of advertising the store. At the time when the user has not yet visited the store, it can be said that the reliability of the blog page is low. The associating unit 235 does not swap the links therebetween at the time when the user has not yet visited the store, thereby making it possible to prevent the website of the store to be linked to the blog page having low reliability. The associating unit 235 links the website of the store to the blog page when the user actually visits the store, thereby making it possible to link the website of the store to the blog page having high reliability.

7-3. Notification Processing

In the example of the embodiment described above, the notifying unit 234 notifies the administrator or the like of the store that the user has actually visited the store. The notification, however, is not limited to the manner described in the example. The notifying unit 234 may notify the administrator or the like of the store of the visiting record stored in the user information storage unit 221. For example, the notifying unit 234 may notify the administrator or the like of the store of a rate of the number of times the user has actually visited the store to the number of times the user posts the articles stating the planned visiting to the shop, the number of times the user visited the store, and the number of types of stores the user visited. As a result, the administrator or the like of the store can determine the level of an incentive to be given to the user on the basis of the visiting record notified from the notifying unit 234. For example, the administrator or the like of the store may give the incentive in such a manner that the larger the number of times a user visited the store, the higher the incentive to be given to the user.

The notifying unit 234 may notify the administrator or the like of the store of the difference between the date when a user posted the blog page and the date when the user visited the store. Specifically, the identifying unit 231 also acquires the posting date when the blog page was posted acquiring the blog page from the web server 100, and also stores the acquired posting date in the user information storage unit 221. The notifying unit 234 calculates a time difference between the posting date and the visiting date stored in the visiting record of the user information storage unit 221, and notifies the administrator or the like of the calculated time difference when the store where the user is present is the same as the planned visiting store as a result of the check performed by the checking unit 233. As a result, the administrator or the like of the store can determine the level of the incentive to be given to the user in accordance with the time difference between the time when the user posted the blog page and the time when the user actually visits the store. For example, the administrator or the like of the store can give the incentive in such a manner that the larger the time difference, the higher the incentive to be given to the user on the basis of the determination that the larger the time difference the higher the preliminary advertising effect on the blog page.

The notifying unit 234 may notify the administrator or the like of the store of a product the user plans to buy. Specifically, the identifying unit 231 analyzes the blog page posted by the user and extracts the product the user plans to buy in addition to the planned visiting store and the planned visiting date. For example, in the example of the blog page B10 of FIG. 1, the identifying unit 231 extracts a “camera” as a product the user plans to buy. The identifying unit 231 stores also the extracted product the user plans to buy in the user information storage unit 221. The notifying unit 234 notifies the administrator or the like of the store of the product the user plans to buy in addition to that the user has actually visited the store, when the store where the user is present is the same as the planned visiting store as a result of check performed by the checking unit 233. Accordingly, the administrator or the like of the store can give an incentive such as a discount on the product to the user who is visiting the store, thereby making it possible to promote a buying motive of the user. As a result, this can increase the profit of the store.

7-4. Ex-Post Evaluation

In the embodiment described above, the identifying unit 231 may acquire a posting page posted by a user who actually visited the store, after the visit, from the web server 100 and analyze the acquired posting page so as to find out whether the user, who had visited the store, further posted the user's impressions of the store. The notifying unit 234 may notify the administrator or the like of the store that the user who had visited the store posted the impressions of the store as a post-evaluation. As a result, the administrator or the like of the store can give a high incentive to the user who had made a preliminary visiting announcement (posting of the store information), actually visited the store, and further posted the ex-post evaluation (impressions of the store). This incentive can promote the user to post the ex-post evaluations, thereby making it possible to further enhance the effect of advertising the store using the web page posted by the user.

7-5. Event Site

In the example of the embodiment described above, the user visits the store. The network system 1 is not limited to being applied to the example. The network system 1 is also applicable to a case where a user visits a site (various facilities such as event sites and public facilities). For example, there is a case where a user posts an article relating to a planned event on a blog page and thereafter visits the event site. Also in such a case, the organizer or the like of the event can obtain an advertising effect from the preliminary posting of the article relating to the event. The information providing apparatus 200, thus, may notify the event organizer or the like that the user visits the event site in the case that a user posted an article relating to the event site and actually visited the event site.

7-6. Others

In the processes described in the embodiment, all or a part of the processes described to be automatically performed can also be manually performed. Alternatively, all or a part of the processes described to be manually performed can also be automatically performed by known methods. In addition, the processing procedures, the specific names, and information including various types of data and parameters described in the above text and drawings can be arbitrarily modified, unless otherwise specified. For example, the various types of information illustrated in the respective drawings are not limited to them.

Furthermore, the components of the apparatus and the like illustrated in the drawings are functionally conceptual ones, and are not always required to be physically configured as illustrated in the drawings. That is, specific forms of distributions and integrations of the apparatus and the like are not limited to those illustrated in the drawings. All or a part of the apparatus and the like can be configured to be functionally or physically distributed or integrated in arbitrary units in accordance with various loads, the usage states, and the like.

For example, the web server 100 and the information providing apparatus 200 may be structured as a single apparatus unlike in the embodiment described above in which the web server 100 and the information providing apparatus 200 are separate. That is, the information providing apparatus 200 may receive the posting of blog pages in the same manner as the web server 100.

In the example described above, the web server 100 is the blog server. The web server 100, however, is not limited to the example. For example, the web server 100 may be a server that provides typical web pages, not blogs, or a Twitter (registered trademark) server that provides Twitter services.

8. Advantages

As described above, the information providing apparatus 200 in the embodiment includes the identifying unit 231, the checking unit 233, and the notifying unit 234. The identifying unit 231 identifies the store or the site which a user plans to visit by analyzing a blog page (corresponding to an example of a web page) posted by the user. The checking unit 233 checks the current location of the user terminal 10 which the user has against the location of the store or the site identified by the identifying unit 231 when the user terminal performs processing to register the current location. The notifying unit 234 notifies the administrator of the store or the site that the user has actually visited the store or the site when the current location of the user terminal 10 is the same as the location of the store or the site as a result of the check performed by the checking unit 233.

Accordingly, the information providing apparatus 200 in the embodiment can associate the user who posted the article relating to the store with the user who has actually visited the store. As a result, the administrator of the store can recognize that the user who preliminarily posted the article stating the visit of the user to the store has actually visited the store, thereby making it possible to give an incentive to the user for preliminarily advertising the store on the web page. That is, the information providing apparatus 200 in the embodiment can promote users to post information of the store, thereby making it possible to enhance the effect of advertising the store or the like using the web pages posted by the users.

With an increase in postings of article data by users, in which correct and detailed store information is written, the identifying unit 231 can identify the stores the users plan to visit with high accuracy. This increases the checking accuracy of the checking unit 233, thereby making it possible to increase possibility to give incentives to the users. The services performed by the information providing apparatus 200 in the embodiment can promote users to post the article data in which correct and detailed store information is written, thereby making it possible to enhance quality of the posting pages (such as blog pages).

The associating unit 235 of the information providing apparatus 200 in the embodiment swaps the links between the posting page and the website (corresponding to an example of the web page) of the store or the site when the current location of the user terminal 10 is the same as the location of the store or the site.

As a result, the information providing apparatus 200 in the embodiment can promote browsing users who browse the website of the store to browse the blog pages posted by users who visited the store, and also promote browsing users who browse the blog pages to browse the website of the store, thereby making it possible to further enhance the effect of advertising the store.

The user information storage unit 221 of the information providing apparatus 200 in the embodiment stores therein for each user the visiting record (corresponding to an example of an action record) indicating whether the user actually visited the planned visiting store or the site. The associating unit 235 determines whether to link the posting page and the store page to each other on the basis of the visiting record stored in the user information storage unit 221.

As a result, the information providing apparatus 200 in the embodiment can associate the blog pages posted by users who have actually visited the store with high certainty with the home page of the store, thereby making it possible to promote browsing users who browse the home page of the store to browse the blog pages having high credibility and reliability.

The notifying unit 234 of the information providing apparatus 200 in the embodiment further notifies the administrator of the visiting record stored in the user information storage unit 221 when the current location of the user terminal 10 is the same as the location of the store or the site.

As a result, the administrator or the like of the store in the embodiment can determine the level of the incentive to be given to the user on the basis of the visiting record notified from the notifying unit 234.

The associating unit 235 of the information providing apparatus 200 in the embodiment links the posting page to the store page when a posting page is posted, and links the store page to the posting page when the current location of the user terminal 10 is the same as the location of the store or the site.

As a result, the information providing apparatus 200 in the embodiment can prevent the website of the store to be linked to the blog page having low reliability, and can link the website of the store to the blog page having high reliability by linking the website of the store to the blog page when the user actually visits the store.

The notifying unit 234 of the information providing apparatus 200 in the embodiment further notifies the administrator of a difference between the date when the posting page was posted and the date when the user actually visited the store or the site.

As a result, the administrator or the like of the store in the embodiment can determine the level of the incentive to be given to the user in accordance with the time difference between the time when the user posted the blog page and the time when the user actually visited the store.

The embodiment of the present application has been described in detail with reference to the accompanying drawings as a way of example. The invention can be implemented in other embodiments changed or modified on the basis of the knowledge of the persons skilled in the art besides the embodiment described herein.

The web server 100 or the information providing apparatus 200 may be achieved by a plurality of server computers. The structure thereof can be changed flexibly. For example, some functions are achieved by calling external platforms using an application programming interface (API) or a network computing system.

The term “unit” described in the accompanying claims can be replaced with a section or a module, for example. For example, an identifying unit can be replaced with an identifying section or an identifying circuit.

An aspect of the embodiment has an advantage of making it possible to enhance the effect of advertising the store and the like using the web pages posted by the users.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information providing apparatus, comprising:
an identifying unit which identifies a store or a site which a user plans to visit by analyzing a posting page posted by the user;
a checking unit which checks a current location of a user terminal which the user has against a location of the store or the site identified by the identifying unit when the user terminal performs processing to register the current location; and
a notifying unit which notifies an administrator of the store or the site that the user has actually visited the store or the site when the current location of the user terminal is the same as the location of the store or the site as a result of the check performed by the checking unit.

2. The information providing apparatus according to claim 1, further comprising:
an associating unit which swaps links between the posting page and a store page that is a web page relating to the store or the site when the current location of the user terminal is the same as the location of the store or the site.

3. The information providing apparatus according to claim 2, further comprising:
a user information storage unit which stores therein for each user an action record indicating whether the user actually visited the store or the site the user plans to visit, wherein
the associating unit determines whether the links are swapped between the posting page and the store page in accordance with the action record stored in the user information storage unit.

4. The information providing apparatus according to claim 3, wherein
the notifying unit further notifies the administrator of the action record stored in the user information storage unit when the current location of the user terminal is the same as the location of the store or the site.

5. The information providing apparatus according to claim 2, wherein
the associating unit links the posting page to the store page when the posting page is posted, and links the store page to the posting page when the current location of the user terminal is the same as the location of the store or the site.

6. The information providing apparatus according to claim 1, wherein
the notifying unit further notifies the administrator of a difference between a date when the posting page was posted and a date when the user actually visited the store or the site.

7. An information providing method performed by an information providing apparatus, the information providing method comprising:
identifying a store or a site which a user plans to visit by analyzing a posting page posted by the user;
checking a current location of a user terminal which the user has against a location of the store or the site identified at the identifying when the user terminal performs processing to register the current location; and
notifying an administrator of the store or the site that the user has actually visited the store or the site when the current location of the user terminal is the same as the location of the store or the site as a result of the check at the checking.

8. The information providing method according to claim 7, further comprising:
swapping links between the posting page and a store page that is a web page relating to the store or the site when the current location of the user terminal is the same as the location of the store or the site.

9. The information providing method according to claim 8, wherein
the swapping includes determining whether the links are swapped between the posting page and the store page in accordance with an action record stored in a user information storage unit, the user information storage unit storing therein for each user the action record indicating whether the user actually visited the store or the site the user plans to visit.

10. The information providing method according to claim 9, wherein
the notifying includes notifying the administrator of the action record stored in the user information storage unit when the current location of the user terminal is the same as the location of the store or the site.

11. The information providing method according to claim 8, wherein
the swapping includes linking the posting page to the store page when the posting page is posted, and linking the store page to the posting page when the current location of the user terminal is the same as the location of the store or the site.

12. The information providing method according to claim 7, wherein
the notifying includes notifying the administrator of a difference between a date when the posting page was posted and a date when the user actually visited the store or the site.

13. A non-transitory computer-readable storage medium with an executable program stored thereon, wherein the program instructs a computer to perform:
identifying a store or a site which a user plans to visit by analyzing a posting page posted by the user;
checking a current location of a user terminal which the user has against a location of the store or the site identified at the identifying when the user terminal performs processing to register the current location; and
notifying an administrator of the store or the site that the user has actually visited the store or the site when the current location of the user terminal is the same as the location of the store or the site as a result of the check at the checking.

14. The non-transitory computer-readable storage medium according to claim 13, further instructing the computer to perform:
swapping links between the posting page and a store page that is a web page relating to the store or the site when the current location of the user terminal is the same as the location of the store or the site.

15. The non-transitory computer-readable storage medium according to claim 14, wherein
the swapping includes determining whether the links are swapped between the posting page and the store page in accordance with an action record stored in a user information storage unit, the user information storage unit storing therein for each user the action record indicating whether the user actually visited the store or the site the user plans to visit.

16. The non-transitory computer-readable storage medium according to claim 15, wherein
the notifying includes notifying the administrator of the action record stored in the user information storage unit when the current location of the user terminal is the same as the location of the store or the site.

17. The non-transitory computer-readable storage medium according to claim 14, wherein
the swapping includes linking the posting page to the store page when the posting page is posted, and linking the store page to the posting page when the current location of the user terminal is the same as the location of the store or the site.

18. The non-transitory computer-readable storage medium according to claim 13, wherein
the notifying includes notifying the administrator of a difference between a date when the posting page was posted and a date when the user actually visited the store or the site.
